(19) United States
(12) Patent Application Publication
(10) Pub. No.: US 2004/0225760 A1
(43) Pub. Date: Nov. 11, 2004

(54) Method and apparatus for transferring data at high speed using direct memory access in multi-processor environments

(75) Inventor: Seung-Bum Lee, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/844,805

(22) Filed: May 13, 2004

(30) Foreign Application Priority Data
May 11, 2003 (KR) 78139/2003

(51) Int. Cl. G06F 13/28

(52) U.S. Cl. 710/22

(57) ABSTRACT

Disclosed is a method for transferring data between processors in a control apparatus including a multi-processor including a first processor and a second processor and first and second local memories related to each of the first and second processors. The method provides a multi-bus DMA controller operating as a master for a first bus for transferring data between the first processor and the first local memory and a second bus for transferring data between the second processor and the second local memory and adapted to perform direct access to the two local memories, transfers a transfer request for data including DMA setting data to the multi-bus DMA controller so that one of the first and second processors transfers the data to another of the first and second processors, and monitors by the multi-bus DMA controller to determine whether the first and second buses are busy based on the DMA setting data and performing the data transfer when the first and second buses are not busy.

### PRIORITY

This application claims priority to an application entitled “METHOD AND APPARATUS FOR TRANSFERRING DATA AT HIGH SPEED USING DIRECT MEMORY ACCESS IN MULTI-PROCESSOR ENVIRONMENTS” filed in the Korean Industrial Property Office on Nov. 5, 2003 and assigned Serial No. 2003-78139, the contents of which are herein incorporated by reference.

### BACKGROUND OF THE INVENTION

1. Field of the Invention

The present invention relates to a method and apparatus for transferring data at high speed using direct memory access (hereinafter, abbreviated as “DMA”) in multi-processor environments.

2. Description of the Related Art

With a shift in mobile communication technologies from processing of voice data to processing of multimedia data, such as moving pictures, complexity of processing of data in mobile communication terminals has increased. Recently, a processor system has been changing from existing single processor architecture for processing voice calls into a multi-processor architecture including two or more processors.

Such a processor system with the multi-processor architecture generally includes processors of two types, for example, a modem processor for performing a time critical mobile communication function and an application processor requiring a high computing power to allow multimedia data processing. These two processors operate using distinct software. Data communication functions between processors in the multi-processor architecture are must be secured, as they are most important of the terminal's functions.

Because most of the software data is stored in memory, there is a need to transfer data between processors through the memory. Since multi-processor architectures in current use include multiple chips, as opposed to one chip in which the modem processor and the application processor are integrated as one unit, they do not have an architecture which can perform high speed data processing between the modem processor and the application processor.

In this multi-chip architecture, memories accessible by the application processor and the modem processor are provided as peripherals outside a modem. Namely, these memories can be considered as externally accessible.

FIG. 1 is a block diagram illustrating a memory readout operation in a conventional multi-processor system. Referring to FIG. 1, the control apparatus includes a modem processor unit 10 for performing a modem function and an application processor unit 20 for processing applications. The modem processor unit 10 includes a modem processor 12, a local memory 16 used for storing data related to the modem processor 12, and a DMA controller 14 for quickly and easily accessing a dual port memory 60. Similarly, the application processor unit 20 includes an application processor 22, a local memory 26 used for storing data related to the application processor 22, a dual port memory 60 to be used for data exchange with the modem processor unit 10, and a DMA controller 24 for quickly and easily accessing the dual port memory 60:

The dual port memory 60 operates as a shared memory between the modem processor unit 10 and the application processor 20. From the viewpoint of the modern processor 12, the dual port memory 60 is an external memory. Therefore, the modem processor 12 is slow in reading data stored in the dual port memory 60. If this DMA controller is riot present, the modem processor 12 or the application processor 22 has to copy data to be transferred into the dual port memory 60, and then, copy the data stored in the dual port memory 60 into each of the local Memories 16 and 26.

On the other hand, the modem processor 12 or the application processor 22 can use a DMA system in order not to participate in data transfer. In the data transfer using the DMA system, the DMA controllers 14 and 24 copy data from the dual port memory 60 and store it in each of the local memories 16 and 26. However, an interrupt controller connected to each of the processors 12 and 24 informs only the processor requesting data transfer, of data transfer completion. Therefore, a problem arises in that the processor requesting the data transfer has to inform a processor receiving the data of the data transfer completion.

### SUMMARY OF THE INVENTION

Therefore, the present invention has been made in an effort to solve the problem occurring in the prior art, and an object of the present invention is to provide a method and apparatus for quickly exchanging data between multiple processors in a control apparatus including multiple processors.

In accordance with an aspect of the present invention, the above and other objects can be accomplished by the provision of a control apparatus including a multi-processor, the multi-processor including a first processor and a second processor, the apparatus comprising: first and second local memories related to the first and second processors, respectively; a first bus for transferring data between the first processor and the first local memory; a second bus for transferring data between the second processor and the second local memory; and a multi-bus direct memory access (DMA) controller operating as a master for the first bus' and the second bus and adapted to perform direct access to the two local memories.

In accordance with another aspect of the present invention, there is provided a method for transferring data between a first and a second processors in a control apparatus, the apparatus comprising a multi-processor including the first processor and the second processor, and a first and a second local memories related respectively to the first and second processors, the method comprising the steps of: a) providing a multi-bus direct memory access (DMA) controller operating as a master for a first bus for transferring data between the first processor and the first local memory and a second bus for transferring data between the second processor and the second local memory and adapted to perform direct access to the two local memories; b) by one of the first and second processors, transferring a data transfer request including DMA setting data to the multi-bus DMA controller to transfer data to the other of the first and second processors; and c) monitoring by the multi-bus DMA controller to determine whether the first and second buses are busy based on the DMA setting data and performing the data transfer when the first and second buses are not busy.

### BRIEF DESCRIPTION OF THE DRAWINGS

The foregoing and other objects, features, and advantages of the present invention will become more apparent from the following detailed description when taken in conjunction with the accompanying drawings in which:

FIG. 1 is a block diagram illustrating a memory readout operation in a conventional multi-processor system;

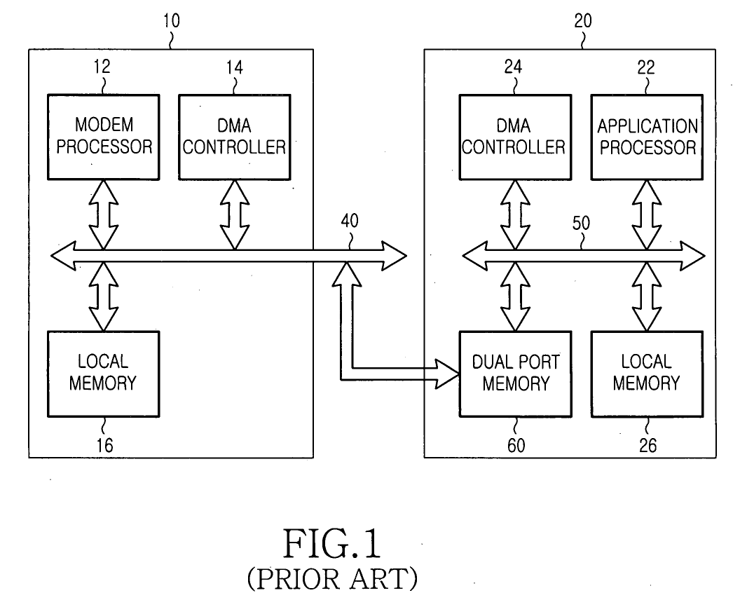

FIG. 2 is a block diagram of a control apparatus including a multi-processor including a multi-bus DMA controller in accordance with the present invention; and

FIG. 3 is a flow chart illustrating a control process of the DMA controller in accordance with an embodiment of the present invention.

### DETAILED DESCRIPTION OF THE PREFERRED EMBODIMENT

Reference will now be made in greater detail to preferred embodiments of the present invention. In the following description of the present invention, the detailed description of known functions and configurations incorporated herein will be omitted when it may make the subject matter of the present invention rather unclear.

The present invention allows high speed data transfer by means of a multi-bus DMA controller. For this purpose, the multi-bus DMA controller is designed to control a plurality of buses connected to a multi-processor. Particularly, the multi-bus DMA controller operates as a master for the plurality of buses used in the multi-processor, respectively. The multi-bus DMA controller is connected to each interrupt controller used independently in each processor in the multi-processor. Accordingly, when the multi-bus DMA controller transfers data from one processor of the multi-processor to another processor of the multi-processor according to a data transfer request, it informs the other processor of the completion of data transfer so that each processor of the multi-processor performs a respective operation.

This use of the multi-bus DMA controller allows the data transfer to be performed without a need to control any processor of the multi-processor control apparatus when data is copied from a memory connected to one bus into a memory connected to another bus. As a result, a shared memory in addition to a separate external memory is not required.

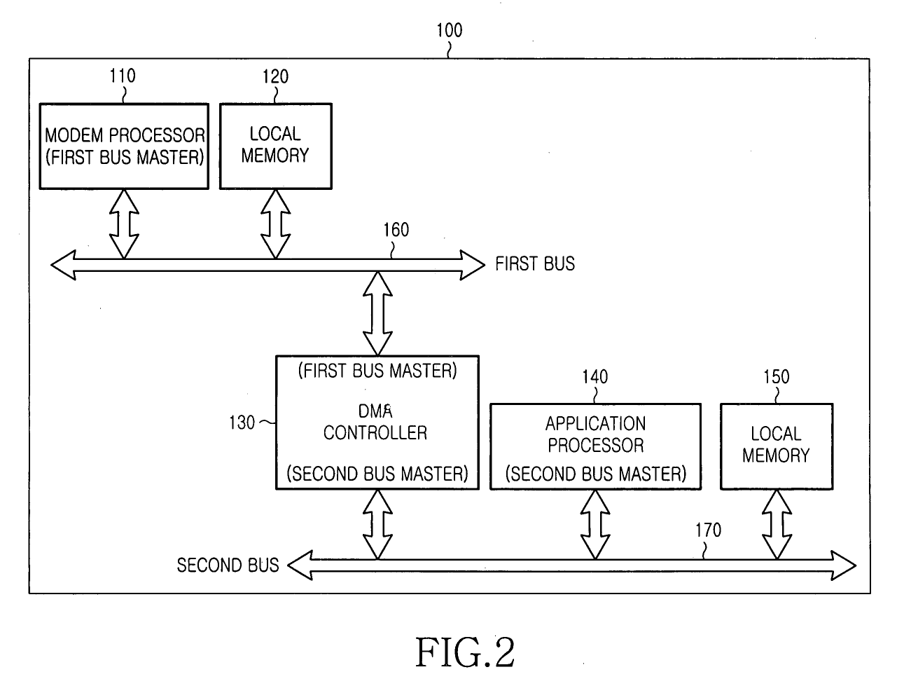

FIG. 2 is a block diagram of a control apparatus including a multi-processor with a multi-bus DMA controller in accordance with the present invention. Referring to FIG. 2, a multi-processor control apparatus 100 in accordance with the present invention includes a first processor 110 used for controlling a modem unit, a second processor 140 used for controlling applications, first and second local memories 120 and 150 related to these two processors, respectively, a first bus 160 used for data transfer between the first processor 110 and the first local memory 120, a second bus 170 used for data transfer between the second processor 140 and the second local memory 150, and a multi-bus DMA controller 130 operating as a master controller for the first and second buses 160 and 170 and enabling a direct access operation to the two local memories 120 and 150.

As can be seen from the above, unlike the prior art, the multi-processor control apparatus 100 using the multi-bus DMA controller 130 in accordance with the present invention does not require a shared memory. This is because data can be copied from a local memory of one processor into a local memory of another processor using a DMA channel of the multi-processor DMA controller 130.

The operation of the multi-processor DMA controller 130 of the present invention will now be described.

Assuming that data is being transferred from the first local memory 120 of the first processor 110 to the second local memory 150 of the second processor 140. To transfer the data, the first processor 110 designates a source address at which the data to be transferred is located, a source data length, and a source memory bus. In addition, the first processor 110 designates a destination address at which the transferred data is to be stored and a destination memory bus. The first processor 110 requests the multi-bus DMA controller 130 to transfer the designated data. This data transfer request includes DMA setting data comprising the source address at which the data to be transferred is located, the source data length, the source memory bus, the destination address at which the transferred data is stored, and the destination memory bus. It is noted that this is only an exemplary list and the DMA setting data is not limited thereto.

When the multi-bus DMA controller 130 receives the data transfer request from the first processor 110 to transfer the data stored in the first local memory 120 to the second local memory 150 of the second processor 140, it reads the DMA setting data included in the data transfer request from the first processor 110.

The multi-bus DMA controller 130 reads the data from a location of a corresponding local memory according to the source address included in the DMA setting data at which the data to be transferred is located. Then, the multi-bus DMA controller 130 checks whether a destination data bus is busy in order to write the read data into a location of the destination address of a local memory to store the data. The term ‘busy’ means that the destination data bus is being used to transfer data. If the destination data bus is not busy or exits from the busy status, the multi-bus DMA controller 130 begins to write the read data into the location of the destination address of the destination memory. In other words, the multi-bus DMA controller 130 monitors whether the source/destination bus is busy and performs the data transfer while the source/destination bus is not busy. Then, the multi-bus DMA controller 130 increments the source address at which the source data to be transferred is stored and the destination address into which the source data is written until all data from the source address is written into the destination memory at the provided destination address.

When the data transfer is completed, the multi-bus DMA controller 130 informs the first and second processors 110 and 140 connected to the source/destination bus of the completion of the data transfer by using an interrupt signal. This interrupt signal is transmitted to interrupt controllers of the first and second processors 110 and 140 so that each processor can individually perform an operation to be performed after the DMA copy is completed.

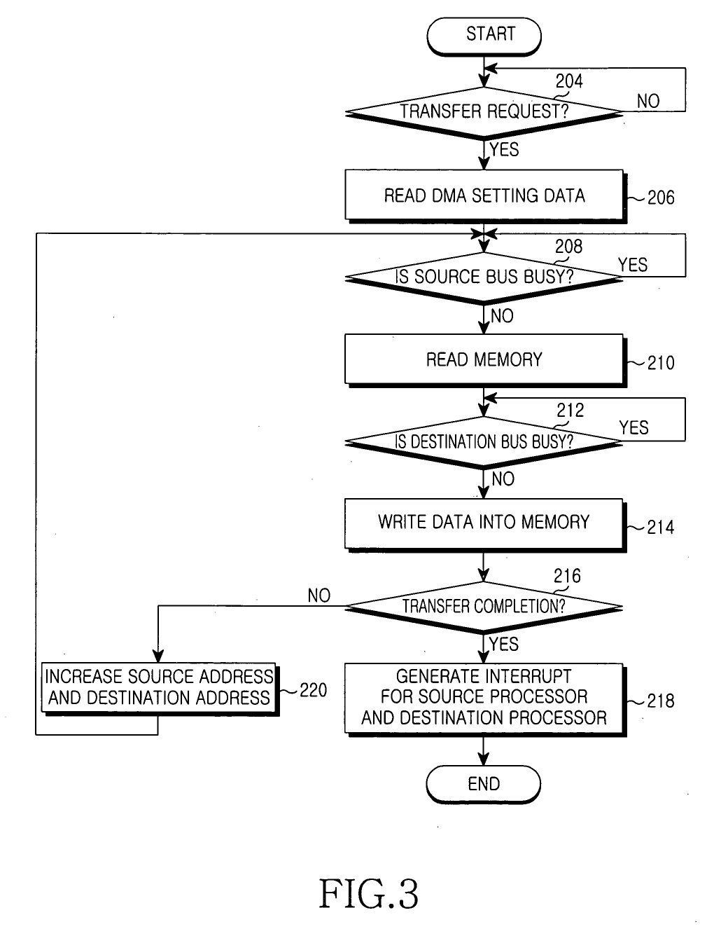

The operation of the multi-bus DMA controller 130 will now be described with reference to FIG. 3, which is a flowchart illustrating a control process of the DMA controller in accordance with an embodiment of the present invention.

In the present embodiment of the present invention, it is assumed that the processor attempting to transfer the data is the first processor 110 and the memory at which the data is located is the first local memory 120. In addition, it is assumed that the processor to which the data is transferred is the second processor 140 and the memory (a destination memory) into which the data is written is the second local memory 150.

The first processor 110 designates the source address, the source data length, and the source memory bus of the first memory 120 at which the data to be transferred is located. In addition, the first processor 110 designates the destination address at which the transferred data is stored and the destination memory bus of the second local memory 150. The first processor 110 requests the multi-bus DMA controller 130 to transfer the data.

Referring to FIG. 3, in step 204 it is determined whether the multi-bus DMA controller 130 receives a request for transfer of data stored in the first local memory 120 to the second local memory 150 of the second processor 140 from the first processor 110.

Upon determining in step 204 that the data transfer request from the first processor 110 has been received, in step 206 the multi-bus DMA controller 136 reads the DMA setting data included in the data transfer request from the first processor 110. The DMA setting data includes data regarding the source address, the source data length, the source memory bus of the first local memory 120 at which the data to be transferred is located, and the destination address and the destination memory bus of the second memory 150 into which the data is transferred and stored.

Here, the source address of the data is an address of the first local memory 120 from which the data is read and the destination address of the data is an address of the second local memory 150 into which the data is written. The first bus 160 is a bus connected to the first local memory 120 and the second bus 170 is a bus connected to the second local memory 150. In accordance with present invention, the multi-bus DMA controller 130 is connected to both of the first and second buses 160 and 170. The multi-bus DMA controller 130 operates as a master controller of these buses and is able to control the transmission of the data on the two buses 160 and 170.

Next, in step 208, the multi-bus DMA controller 130 determines whether the first bus 160 is busy. If it is determined that the first bus 160 is not busy, the multi-bus DMA controller 130 reads the data from a location of the first local memory according to the source address, at which the data to be transferred is located, included in the DMA setting data in step 210.

Then, in order to store the read data, the multi-bus DMA controller 130 determines in step 212 whether the second bus 170 is busy. If it is determined that the second bus 170 is not busy, the data is written into a location of the destination address of the second local memory 150 in step 214. The term ‘busy’ means that the destination data bus is being used to transfer data. In other words, the multi-bus DMA controller 130 monitors whether the source/destination bus (for example, the first/second bus 160/170) is busy and performs the data transfer while the source/destination bus 160/170 is not busy.

Next, in step 216 the multi-bus DMA controller 130 determines whether the data transfer from the first local memory 120 to the second local memory 150 completed. The multi-bus DMA controller 130 performs such a determination on the basis of the DMA setting data included in the data transfer request from the first processor 110. Since the DMA setting data includes information on the source data length, the multi-bus DMA controller 130 can know whether all the data to be transferred has been transferred from the first local memory 120 to the second local memory 150.

If all the data has not been transferred from the first local memory 120 to the second local memory 150, the multi-bus DMA controller 130 increments the source address and the destination address until all the data from the source address is written into the destination address in step 220. In other words, the multi-bus DMA controller 130 does not transfer all the data on the bus at once, but transfers data segments, which are derived from sequential division of the data into packets. For example, if the multi-bus DMA controller 130 transfers data “11110000” at an address of 102 and data “00001111” at an address of 103, it first transfers the data “11110000” stored at the address 102 which is a start address of the source data, and then, increments the start address of the source data and transfers the data “00001111” stored in the address of 103. If 16 bit data packets are transferred at once, the multi-bus DMA controller 130 adds an amount of address increase by a data transfer unit to the start address of the source data, so that the start address of the source data is again decided.

When the data transfer is completed in step 218, the multi-bus DMA controller 130 informs the first and second processors 110 and 140 connected to the source/destination bus 160/170 of the completion of the data transfer by using the interrupt signal. This interrupt signal is transmitted to interrupt controllers of both of the first and second processors 110 and 140 so that each processor can perform an operation to be performed after the DMA copy is completed.

As is apparent from the above description, since the multi-bus DMA controller operates as a master for two buses used in the multi-processor, the data transfer can be performed with no need to control any processor of the multi-processor when the data is copied from a memory connected to one bus into a memory connected to another bus. As a result, a shared memory is not required in addition to a separate external memory.

While the preferred embodiment of the present invention has been disclosed for illustrative purpose, those skilled in the art will appreciate that various modifications, additions and substitutions are possible, without departing from the scope and spirit of the invention as disclosed in the accompanying claims. For example, although the multi-processor includes two processors in the preferred embodiment, it will be apparent to those skilled in the art that it may include more than two processors and the multi-bus DMA controller operates as a master for buses connected to each of more than two processors. Therefore, the scope of the invention should be defined by the accompanying claims, not by the illustrated embodiment.

What is claimed is:

1. A control apparatus including a multi-processor, the multi-processor including a first processor and a second processor, the apparatus comprising:
first and second local memories related to the first and second processors, respectively;
a first bus for transferring data between the first processor and the first local memory;
a second bus for transferring data between the second processor and the second local memory; and
a multi-bus direct memory access (DMA) controller operating as a master controller for the first bus and the second bus and adapted to perform direct access to the first and second local memories.

2. The control apparatus as set forth in claim 1, wherein the first processor controls a modem unit and the second processor controls applications.

3. The control apparatus as set forth in claim 1, wherein the first and second processors each-transfer a data transfer request to the multi-bus DMA controller, the data transfer request including DMA setting data required to transfer data between the first and second processors.

4. The control apparatus as set forth in claim 3, wherein the DMA setting data includes at least one of a source address, a source data length, and a source memory bus of one of the first and second local memories at which specific the data to be transferred is located, and a destination address and a destination memory bus of the other of the first and second local memories into which the specific data is transferred and stored.

5. The control apparatus as set forth in claim 4, wherein, when the data transfer is completed, the multi-bus DMA controller informs the first and second processors connected respectively to the first and second buses of the completion of the data transfer.

6. A method for transferring data in a a multi-processor control apparatus, the apparatus including a first processor and a second processor, and first and second local memories related respectively to the first processor and the second processor, and a multi-bus direct memory access (DMA) controller connected to a first bus related to the first processor and a second bus related to the second processor, the method comprising the steps of:
a) transferring a data transfer request by the first processor, the data transfer request including DMA setting data to the multi-bus DMA controller to transfer data to the second processors; and
b) monitoring by the multi-bus DMA controller to determine whether the first and second buses are busy; and
c) directly accessing the first and second memories through the first and second bus based on the DMA setting data and transferring the data from the first memory to the second memory when the first and second buses are not busy.

7. The method as set forth in claim 6, wherein the DMA setting data includes at least one of a source address, a source data length, and a source memory bus of one of the first and second local memories at which specific data to be transferred is located, and a destination address and a destination memory bus of the other of the first and second local memories into which the specific data is transferred and stored.

8. The method as set forth in claim 6, wherein the first processor controls a modem unit and the second processor controls applications.

9. The method as set forth in claim 6, further comprising the step ofi d) when the data transfer is completed, informing by the multi-bus DMA controller the first and second processors connected respectively to the first and second buses of the completion of the data transfer.

10. A control apparatus including a multi-processor comprising at least two processors, the control apparatus comprising:
a plurality of local memories, each of the local memories related to the at least one of the at least two processors;
a plurality of buses for transferring data between each of the at least two processors and the plurality of local memories related to the at least two processors; and
a multi-bus direct memory access (DMA) controller operating as a master controller for each of the plurality of buses and adapted to perform direct access to each of the plurality of local memories.
